(19) United States
(12) Patent Application Publication
(10) Pub. No.: US 2025/0342604 A1
(43) Pub. Date: Nov. 6, 2025

(54) Lightweight attention mechanism distance estimation method for assisting visual navigation of a vehicle at a container terminal

(71) Applicants: Shanghai Maritime University, Shanghai (CN); Shanghai Ship and Shipping Research Institute, Shanghai (CN)

(72) Inventors: Xinqiang Chen, Shanghai (CN); Fei Ma, Shanghai (CN); Zichuang Wang, Shanghai (CN); Yiwen Zheng, Shanghai (CN); Bing Han, Shanghai (CN); Han Zhang, Shanghai (CN)

(21) Appl. No.: 19/267,548

(22) Filed: Jul. 12, 2025

(30) Foreign Application Priority Data
Mar. 28, 2025 (CN) 202510384151.X

(51) Int. Cl. G06T 7/55; B60W 50/06; B60W 60/00; G01C 3/08; G01C 21/26; G06T 5/30; G06T 5/50; G06T 5/70; G06T 7/80

(52) U.S. Cl. CPC G06T 7/55; B60W 50/06; B60W 60/001; G01C 3/08; G01C 21/26; G06T 5/30; G06T 5/50; G06T 5/70; G06T 7/80; B60W 2420/403; G06T 2207/10024; G06T 2207/10028; G06T 2207/20081; G06T 2207/20084; G06T 2207/20192; G06T 2207/30252

(57) ABSTRACT

The present discloses a lightweight attention mechanism distance estimation method for assisting visual navigation of a vehicle at a container terminal. Firstly, using a depth monocular camera calibrated with the imaging parameters of the planar checkerboard tool to collect RGB-Depth image pairs in the working scenario of the automatic guided vehicle. Secondly, performing depth completion and manual annotation processing on the collected depth image. Thirdly, inputting image pairs into a lightweight monocular metric depth estimation framework which uses an improved lightweight attention mechanism Squeeze Former as the token mixer for training. Finally, fusing the results of relative depth estimation and absolute depth estimation to obtain a prediction of an actual distance between an object in the RGB image and the camera in the real world. The method and model provided by the present invention feature simple equipment, low cost, high timeliness of prediction and accurate results.

### CROSS REFERENCE TO RELATED APPLICATION(S)

This application claims priority to Chinese patent application serial no. CN 202510384151.X, filed on Mar. 28, 2025, the complete disclosure of which, in its entirety, is herein incorporated by reference.

### FIELD OF INVENTION

The present invention relates to the field of computer vision image processing, and specifically to a lightweight attention mechanism distance estimation method for assisting visual navigation of a vehicle at a container terminal.

### BACKGROUND ART

In an automated terminal, a vehicle accurately perceive its relative position relationship with the surrounding environment through distance measurement, enabling high-precision positioning and navigation, planning the optimal driving path, reducing unnecessary detour and waiting time, and thereby enhancing the overall operational efficiency of the terminal. The realization of distance estimation for an automated terminal vehicle based on a monocular camera is an important research work in recent years. Monocular depth estimation belongs to the technology in the field of computer vision, which aims to restore the distance value between each pixel point in a RGB image and a camera in the real world from a single two-dimensional image. In a traditional visual navigation task, the operation of an automatic guided vehicle in an automated terminal usually requires the support of a multitude of hardware facilities, such as the combined use of various hardware devices like lidar, millimeter-wave radar, cameras, and ultrasonic sensors. This not only increases the complexity of the working system but also brings about computational redundancy. In a modern automated terminal, visual navigation, as one of the main application scenario of depth estimation technology, can greatly reduce the complexity of the system and lower the cost of equipment procurement and later maintenance.

When solving the visual navigation task of vehicle distance estimation in an automated dock, existing technologies usually use a deep convolutional neural network to extract image feature in the model coding stage. It is difficult to obtain a large receptive field in the shallow layer of the network, thereby employing distortion in the depth estimation of object edge in the image. Some other existing technologies use a backbone network based on the Transformer architecture for extracting global feature. During this process, the calculation of the self-attention mechanism requires a large amount of computing resources and memory, and for processing large-scale image data, it requires a huge number of model parameters and computing power.

The existing technologies have put forward relatively high requirement for the acquisition device. Usually, a binocular or a multi-purpose camera is required, which is expensive and costly, and is difficult to deploy in the actual scenario of the wharf. In addition, in the existing vehicle distance estimation scheme based on computer vision, the structure of the network model used is relatively complex, the number of model parameters is large, and the real-time performance of application deployment is difficult to meet the actual requirement.

### SUMMARY OF THE PRESENT INVENTION

The present invention mainly addresses the issues that the existing vehicle distance estimation schemes for an automated terminal use complex and expensive equipment, have a relatively complex network model structure, are difficult to deploy in real time, cannot balance prediction accuracy and fast reasoning speed with low latency, and the monocular camera usually provide inaccurate prediction of the actual distance, resulting in high costs and an inability to be implemented in different working scenarios of an automatic guided vehicle under an automated terminal. The problem of refined absolute distance estimation provides a lightweight attention mechanism distance estimation method and system for assisting visual navigation of a vehicle at a container terminal, solving the above problems.

A lightweight attention mechanism distance estimation method for assisting visual navigation of a vehicle at a container terminal, comprising the following steps:
(1) capturing a multitude of RGB images and a multitude of depth images in a working scenario of an Automated Guided Vehicle (AGV), by means of employing a depth monocular camera and calibrating the depth monocular camera using a multitude of imaging parameters obtained from a planar checkerboard tool.
(2) conducting depth-completion and manual annotation on the multitude of the depth images, said manual annotation being conducted by a professional by means of labelling or annotating the multitude of the depth images subsequent to depth-completion; correcting the multitude of the depth images of invalid depth-value to generate training data for a lightweight monocular metric depth estimation framework with enhanced attention mechanism; partitioning the training data into a multitude of training datasets, a multitude of validation datasets, and a multitude of test datasets.
(3) inputting the multitude of the training datasets and the multitude of the validation datasets into the lightweight monocular metric depth estimation framework with enhanced attention mechanism for training, to obtain an estimation of distance, comprising the following steps:
(3.1) processing the multitude of the RGB images in the multitude of the training datasets and the multitude of the validation datasets with image embedding, projecting each feature of each RGB image of the multitude of the RGB images into each high-dimensional image long sequence feature image token of a multitude of the high-dimensional image long sequence feature image tokens.
(3.2) encoding the multitude of the high-dimensional image long sequence feature image tokens, said encoding employing a backbone network sequentially stacked with Global Squeeze Blocks, and comprising the following steps: firstly, the improved lightweight attention mechanism Squeeze Former performing feature aggregation on the multitude of the high-dimensional image long sequence feature image tokens; subsequently, inputting the multitude of the high-dimensional image long sequence feature image tokens to an MLP layer to obtain an output; simultaneously, incorporating a multitude of residual connections to model long-range global interdependencies within the multitude of the high-dimensional image long sequence feature image tokens, thereby generating a multitude of coherent image pixel depth feature tokens; said modified lightweight attention mechanism, Squeeze Former, serving as a token mixer, performing average pooling on a key vector matrix (K matrix) and a value vector matrix (V matrix) in a multi-head attention mechanism, employing a learnable linear layer to embed the channel dimensions of a query vector matrix (Q matrix) and the K matrix into one dimension, a front of the improved lightweight attention mechanism Squeeze Former employing a spatial information-based adaptive weighting mechanism, the spatial information-based adaptive weighting mechanism employing a 2D convolutional neural network and incorporating a residual connection.
(3.3) inputting the multitude of the coherent image pixel depth feature tokens in step (3.2) into a decoding module to obtain an estimation of relative depth; simultaneously, inputting the multitude of the coherent image pixel depth feature tokens in step (3.2) into a WT Bins module to obtain an estimation of absolute depth.
(4) fusing the estimation of relative depth and the estimation of absolute depth, comprising the following steps: firstly, applying a SoftMax function to normalize the estimation of relative depth, to obtain a depth probability distribution for each image pixel; secondly, dividing the estimation of absolute depth into a multitude of local intervals, with a default pixel scale of 4×4 for each local interval of the multitude of the local intervals, and calculating a central value of each local interval of the multitude of the local intervals; finally, multiplying the distance central value of each local interval of the multitude of the local intervals by the corresponding probability in the depth probability distribution, realizing the fusing of the estimation of relative depth and the estimation of absolute depth; then output to obtain a prediction of each actual distance between each pixels of each in the multitude of the RGB images and the camera in the real world.

Preferably, wherein the working scenario of the Automated Guided Vehicle (AGV) in step (1) referring to a multitude of working scenarios of AGV in an automated terminal: one or a multitude of traffic cones placed on a multitude of automated terminal roads, special-purpose vehicles operating normally on automated terminal roads, a multitude of containers arranged in one or more yards of the container terminal.

Preferably, wherein said calibrating the depth monocular camera using the multitude of the imaging parameters obtained from a planar checkerboard tool in step (1) comprises: performing calibration according to Zhang's calibration method by employing the planar checkerboard tool to determine the multitude of the imaging parameters of the monocular depth camera, subsequently rectifying a multitude of imaging distortions employing the multitude of the imaging parameters.

Preferably, wherein the depth-completion mentioned in step (2) comprises the following steps:
(2.1) firstly, applying median filtering to the multitude of the depth images to remove noise and isolated pixel points, providing a cleaner data foundation for subsequent hole identification and completion.
(2.2) identifying regions with missing depth value, setting invalid depth value to 0 in the multitude of the depth images, thereby converting the multitude of the depth images into a multitude of binary images, employing numerical judgment to mark invalid pixel as 1 (representing the hole) and valid pixel as 0.
(2.3) applying morphological dilation operation to the multitude of the binary images to expand the edge of the hole, ensuring smooth boundary during subsequent interpolation; employing erosion operation to remove smaller isolated invalid a point to avoid misjudgment, filling the hole with depth value from adjacent valid pixel.

Preferably, wherein a criterion for partitioning the training data in step (2) is as follows: dividing the training data so that the multitude of the training datasets constitute a largest percentage, while the multitude of the validation datasets and the multitude of the test datasets have equal proportion.

Preferably, wherein a mathematical expression for dimensional change of the multitude of the RGB images with the image embedding process in step (3.1) is as follows:

$${I}_{p} ∈ {ℝ}^{N \times ( {P}^{2} \times C )} = proj ( rehape ( I ∈ {ℝ}^{H \times W \times C} ) )$$

wherein I represent each RGB image of the multitude of the RGB images, (H, W) represents the resolution size of each RGB image of the multitude of the RGB images, C represents the number of channels of each RGB image of the multitude of the RGB images.

Preferably, wherein a mathematical expression of the improved lightweight attention mechanism in step (3.2) is as follows:

$$\begin{matrix}SF ( {F}_{l - 1} ) = Concat ( {Head}_{0} , {Head}_{1} , … , {Head}_{j} ) W ° \\ {Head}_{j} = Attention ( Q , K , V ) = Softmax ( \frac{Q \cdot {K}^{T}}{\sqrt{{d}_{k}}} ) V \\ Q = {F}_{l - 1} {W}_{j}^{Q} , K = Avg Pool ( {F}_{l - 1} ) {W}_{j}^{K} , V = Avg Pool ( {F}_{l - 1} ) {W}_{j}^{V}\end{matrix}$$

wherein Q, K, V represent the query vector matrix, the key vector matrix and the value vector matrix in the multi-head attention mechanism respectively,

$${W}_{j}^{Q} ‵ {W}_{j}^{K} ‵ {W}_{j}^{V}$$

and W^{o} are a multitude of projection matrices, j represents an index number of the attention head, AvgPool is an average pooling layer, and Concat is a concatenation operation used to concatenate a multitude of results of a multitude of individual attention heads.

Preferably, wherein the decoding module in step (3.3) comprises a Recover module and a Feature fusion module; the Recover module serves to reassemble the multitude of the high-dimensional image long sequence feature image tokens from the encoding stage into an image-like feature representation, that is, to combine the multitude of the high-dimensional image long sequence feature image tokens according to their original positional encoding and connect them into an image-like feature representation; the Feature fusion module is composed of a combination of a multitude of residual convolutional layers and a multitude of upsampling layers, the multitude of the residual convolutional layers are arranged in a sequential manner with two layers connected one after the other, and a residual connection is used on the outer layer, its function is to further aggregate the image-like feature representation and expand the model's receptive field; finally, placing the multitude of the upsampling layers at an end of the Feature fusion module, employing a linear interpolation to double the size of the image-like feature representation each time.

Preferably, wherein the WT Bins module mentioned in step (3.3) comprises two layers of convolutional neural networks based on wavelet transform, along with an absolute distance estimation module, residual connection is added outside the two layers of wavelet transform-based convolutional neural networks to enhance the low-frequency response of multi-scale feature from the bottleneck of the backbone network and to increase the global receptive field at this stage.

Preferably, employing four evaluation metrics to assess the performance of the method. They are absolute relative error (AbsRel), root mean square error (RMSE), log root mean square error (RMSE_{log}), and pixel threshold accuracy percentage δₙ. Their calculation formulas are shown below:

$$\begin{matrix}AbsRel = \frac{1}{N} \sum \frac{\vert {y}_{i} - {\hat{y}}_{i} \vert}{{y}_{i}} \\ RMSE = \sqrt{\frac{1}{N} \sum {\vert {y}_{i} - {\hat{y}}_{i} \vert}^{2}} \\ {RMSE}_{log} = \sqrt{\frac{1}{N} \sum {\vert log {y}_{i} - log {\hat{y}}_{i} \vert}^{2}} \\ {δ}_{n} = [ max ( \frac{{y}_{i}}{{\hat{y}}_{i}} , \frac{{\hat{y}}_{i}}{{y}_{i}} ) < {thr}^{m} ] \% , thr = 1.25 , m = 1 ‵ 2 ‵ 3\end{matrix}$$

wherein i represents an index of a pixel point in each RGB image of the multitude of the RGB images, yᵢ is the true value of the depth of the pixel point, and ŷᵢ is a depth prediction of the method, N is the total number of pixel points in each RGB image of the multitude of the RGB images.

### BRIEF DESCRIPTION OF THE DRAWINGS

For the purpose of clearly illustrate the technical solution of the invention, a brief description about the drawings is shown as follows:

FIG. 1 is a flowchart of a lightweight attention mechanism distance estimation method for visual navigation of an automated container terminal vehicles of an example of the present invention.

FIG. 2 is a schematic diagram of the structure of the Squeeze Former, an improved lightweight attention mechanism of an example of the present invention.

FIG. 3 is a schematic diagram of the structure of a Recover module of an example of the present invention.

FIG. 4 is a schematic diagram of the overall structure of the WT Bins module of an example of the present invention.

FIG. 5 is a diagram of the prediction effect of each model of each scene of an example of the present invention.

### EMBODIMENTS

To better understand the technical features, objectives and effects of the present invention, the invention is described in more detail as below with the support of accompanying figures. Note that the specific embodiments described herein are intended to explain the invention only, which does not intend to limit the patent of the invention. It should be noted that these figures are presented in a simplified yet easy-understandable manner to help better understand the proposed invention.

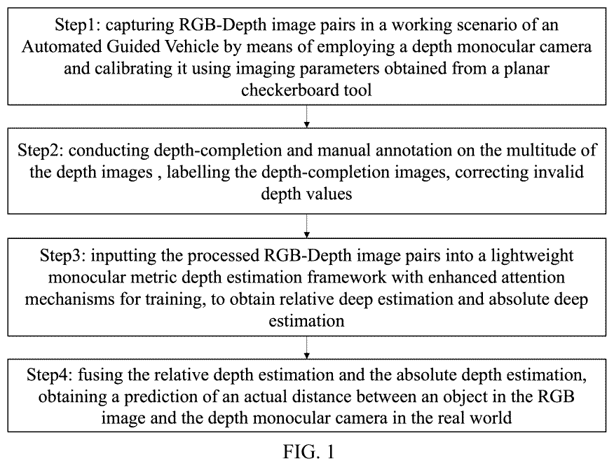

The invention is described in more details as below, which comprises the following steps (see FIG. 1):
(1) capturing a multitude of RGB images and a multitude of depth images in a working scenario of an Automated Guided Vehicle (AGV), by means of employing a depth monocular camera and calibrating the depth monocular camera using a multitude of imaging parameters obtained from a planar checkerboard tool.
(2) conducting depth-completion and manual annotation on the multitude of the depth images, said manual annotation being conducted by a professional by means of labelling or annotating the multitude of the depth images subsequent to depth-completion; correcting the multitude of the depth images of invalid depth-value to generate training data for a lightweight monocular metric depth estimation framework with enhanced attention mechanism; partitioning the training data into a multitude of training datasets, a multitude of validation datasets, and a multitude of test datasets.
(3) inputting the multitude of the training datasets and the multitude of the validation datasets into the lightweight monocular metric depth estimation framework with enhanced attention mechanism for training, to obtain an estimation of distance, comprising the following steps:
(3.1) processing the multitude of the RGB images in the multitude of the training datasets and the multitude of the validation datasets with image embedding, projecting each feature of each RGB image of the multitude of the RGB images into each high-dimensional image long sequence feature image token of a multitude of the high-dimensional image long sequence feature image tokens.
(3.2) encoding the multitude of the high-dimensional image long sequence feature image tokens, said encoding employing a backbone network sequentially stacked with Global Squeeze Blocks, and comprising the following steps: firstly, the improved lightweight attention mechanism Squeeze Former performing feature aggregation on the multitude of the high-dimensional image long sequence feature image tokens; subsequently, inputting the multitude of the high-dimensional image long sequence feature image tokens to an MLP layer to obtain an output; simultaneously, incorporating a multitude of residual connections to model long-range global interdependencies within the multitude of the high-dimensional image long sequence feature image tokens, thereby generating a multitude of coherent image pixel depth feature tokens; said modified lightweight attention mechanism, Squeeze Former, serving as a token mixer, performing average pooling on a key vector matrix (K matrix) and a value vector matrix (V matrix) in a multi-head attention mechanism, employing a learnable linear layer to embed the channel dimensions of a query vector matrix (Q matrix) and the K matrix into one dimension, a front of the improved lightweight attention mechanism Squeeze Former employing a spatial information-based adaptive weighting mechanism, the spatial information-based adaptive weighting mechanism employing a 2D convolutional neural network and incorporating a residual connection.
(3.3) inputting the multitude of the coherent image pixel depth feature tokens in step (3.2) into a decoding module to obtain an estimation of relative depth; simultaneously, inputting the multitude of the coherent image pixel depth feature tokens in step (3.2) into a WT Bins module to obtain an estimation of absolute depth.
(4) fusing the estimation of relative depth and the estimation of absolute depth, comprising the following steps: firstly, applying a SoftMax function to normalize the estimation of relative depth, to obtain a depth probability distribution for each image pixel; secondly, dividing the estimation of absolute depth into a multitude of local intervals, with a default pixel scale of 4×4 for each local interval of the multitude of the local intervals, and calculating a central value of each local interval of the multitude of the local intervals; finally, multiplying the distance central value of each local interval of the multitude of the local intervals by the corresponding probability in the depth probability distribution, realizing the fusing of the estimation of relative depth and the estimation of absolute depth; then output to obtain a prediction of each actual distance between each pixels of each in the multitude of the RGB images and the camera in the real world.

The step (1) comprises the following steps:
(1.1) the working scenario of the Automated Guided Vehicle (AGV) in step (1) referring to a multitude of working scenarios of AGV in an automated terminal: one or a multitude of traffic cones placed on a multitude of automated terminal roads, special-purpose vehicles operating normally on automated terminal roads, a multitude of containers arranged in one or more yards of the container terminal.
(1.2) calibrating the depth monocular camera using the multitude of the imaging parameters obtained from a planar checkerboard tool in step (1) comprises: performing calibration according to Zhang's calibration method by employing the planar checkerboard tool to determine the multitude of the imaging parameters of the monocular depth camera, subsequently rectifying a multitude of imaging distortions employing the multitude of the imaging parameters.

The manufacturing process of depth camera equipment may have error, resulting in distorted image captured. The distortion may have a negative impact on subsequent image processing and analysis. In a machine vision application, if distortion is not corrected, it will lead to inaccurate edge detection of the target object, thereby affecting the accuracy of positioning and measurement. Therefore, after calibrating the camera, we can obtain the internal and external parameter of the camera, which can be used to correct image distortion, conduct 3D reconstruction and make more accurate measurement. Selecting various different scenarios of the port environment for data collection can verify the robustness of this method and improve the anti-interference ability of the model.

The principle of depth completion is that when the maximum depth of the collected scene exceeds the limit collection distance of the depth camera hardware specification, the collected depth data will be distorted. The result is that the collected depth value is NAN (i.e., invalid value) or 0 value. When visualizing the depth map of this scene, multiple holes will appear. The deep completion method is to identify holes by employing image morphological operations, and then fill in the missing parts in the data by employing interpolation methods.

Preferably, wherein the deep completion described in step (2) includes the following steps:
(2.1) firstly, applying median filtering to the multitude of the depth images to remove noise and isolated pixel points, providing a cleaner data foundation for subsequent hole identification and completion.
(2.2) identifying regions with missing depth value, setting invalid depth value to 0 in the multitude of the depth images, thereby converting the multitude of the depth images into a multitude of binary images, employing numerical judgment to mark invalid pixel as 1 (representing the hole) and valid pixel as 0.
(2.3) applying morphological dilation operation to the multitude of the binary images to expand the edge of the hole, ensuring smooth boundary during subsequent interpolation; employing erosion operation to remove smaller isolated invalid a point to avoid misjudgment, filling the hole with depth value from adjacent valid pixel.

Preferably, wherein said specific operation of manual annotation in step (2) is as follows: professionals label or annotate the depth data, correct the unreasonable depth values therein, and make it the precise training data required for the monocular metric depth estimation framework.

Preferably, wherein a criterion for partitioning the training data in step (2) is as follows: dividing the training data wherein the multitude of the training datasets constitute a largest percentage, while the multitude of the validation datasets and the multitude of the test datasets have equal proportion.

In some embodiments of the present invention, the ratio of the training dataset, the validation dataset and the test dataset is 6:2:2.

The step (3) comprises the following steps:
(3.1) wherein a mathematical expression for dimensional change of the multitude of the RGB images with the image embedding process in step (3.1) is as follows:

$${I}_{p} ∈ {ℝ}^{N \times ( {P}^{2} \times C )} = proj ( reshape ( I ∈ {ℝ}^{H \times W \times C} ) )$$

wherein I is the original image, (H, W) is the resolution size of the image, C is the number of channels of the RGB image, Reshape represents the image dimension transformation operation, Iₚ is the transformed image features, N is the number of patches (i.e., for multiple small image squares) generated, computed as N=HW/P2, and P is the dimensionality size of each 2-dimensional patches.

Finally, we use a trainable linear projection layer proj to uniformly project each of the generated patches to dimension D=768, and the long sequence of high-dimensional image features generated by the processing is called image tokens.
(3.2) the image tokens are inputted into Global Squeeze Block, the processing steps are feature aggregation by the improved lightweight attention mechanism Squeeze Former first, and then output by an MLP layer, and the residual linkage mechanism is added in the whole process, and a mathematical expression of the whole process is as follows:

$$\begin{matrix}{F}_{0} = [ {I}_{class} ; {I}_{p}^{1} E ; {I}_{p}^{2} E ; … ; {I}_{p}^{N} E ; ] + {E}_{pos} , E ∈ {ℝ}^{( {P}^{2} \times C ) \times D} , {E}_{pos} ∈ {ℝ}^{( N + 1 ) \times D} \\ {M}_{l} = SF ( LN ( {F}_{l - 1} ) ) + {F}_{l - 1} , l = 1 … L \\ {Z}_{l} = MLP ( LN ( {M}_{l} ) ) + {M}_{l} , l = 1 … L\end{matrix}$$

wherein I_{class} is a learnable Class token added at the first place of image tokens as the final global image representation for classification. E is the unit matrix, and Eₚₒₛ is the position encoding matrix with the same dimension as image tokens. Because for intensive prediction tasks such as depth estimation, the spatial position of pixels is crucial for predicting the depth details of objects. depth details of the edges, so we add the learnable position encoding Eₚₒₛ to the image tokens to compensate for the loss of initial pixel position information generated after reshape of image I. LN stands for the layer normalization operation, SF is the improved lightweight attention mechanism, Mₗ is the intermediate variable after the attention mechanism, and Zₗ is the final result generated after the coding stage processing to generate the final result.

A mathematical expression of the improved lightweight attention mechanism Squeeze Former is as follows:

$$\begin{matrix}SF ( {F}_{l - 1} ) = Concat ( {Head}_{0} , {Head}_{1} , … , {Head}_{j} ) W ° \\ {Head}_{j} = Attention ( Q , K , V ) = Softmax ( \frac{Q \cdot {K}^{T}}{\sqrt{{d}_{k}}} ) V \\ Q = {F}_{l - 1} {W}_{j}^{Q} , K = Avg Pool ( {F}_{l - 1} ) {W}_{j}^{K} , V = Avg Pool ( {F}_{l - 1} ) {W}_{j}^{V}\end{matrix}$$

wherein Q, K, V represent the query vector matrix, key vector matrix and value vector matrix in the multi-head attention mechanism respectively,

$${W}_{j}^{Q} ‵ {W}_{j}^{K} ‵ {W}_{j}^{V}$$

and W^{o} are projection matrices, j represents the index number of the attention head, AvgPool is the average pooling layer, and Concat is the concatenation operation used to concatenate the results of the individual attention heads.

In marked contrast to ordinary attention mechanisms, the improved lightweight attention mechanism Squeeze Former averages the K and V matrices for pooling prior to the attention operation, and then embeds the channel dimensions of Q and K in dimension 1 using a learnable linear layer to further reduce the computational cost.

At this point the dimensions of the Q-matrix and the K-matrix are, Q∈ [symbol] ^{Head×P}^{²}^{×1}, K∈ [symbol] ^{Head×(P}^{²}^{/avgpool}^{²}^{)×1}, this is much lower than the Q and K matrix dimensions produced by ordinary attention mechanisms.

After channel reduction, the computation of attention may ignore the importance of different spatial regions in the image (e.g. target edges, texture regions) and thus fragmentation occurs in unimportant regions such as the image background. Therefor Squeeze Former adds an adaptive spatial information-based weighting mechanism to the input of image tokens, using an adaptive spatial weight map generated by a convolutional layer to augment the original input with features, so that the attention mechanism can flexibly adjust its attention to different spatial locations when aggregating global features, and more accurately capture the global context of the key spatial regions.

A mathematical expression of the computational complexity comparison between the final improved lightweight attention mechanism Squeeze Former and the previously effective SRA attention mechanism is as follows:

$$\begin{matrix}O ( SF ) = {( N )}^{2} \cdot 1 + {( N )}^{2} \cdot C \\ O ( SRA ) = {( N )}^{2} \cdot C + {( N )}^{2} \cdot C\end{matrix}$$

wherein N represents the number of image tokens. By compressing the channel dimensions of the Q and K matrices, Squeeze Former reduces the computation of query key operations by a factor of C. Compared with the previous lightweight and effective SRA attention mechanism, Squeeze Former reduces the total computation of attention operations by about two times, which strongly underpins the real-world of deep estimation tasks application deployment.

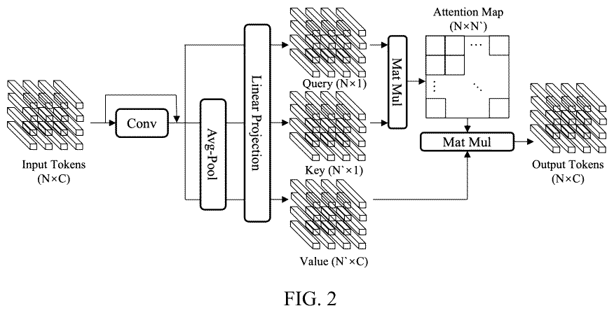

The overall structure and data processing flow of the improved lightweight attention mechanism Squeeze Former are shown in FIG. 2. The front end of Squeeze Former is an adaptive weighting mechanism based on spatial information, implemented using a 2D convolutional neural network, and also employs residual connections. It can be seen from the figure that the dimensions of both the Q and K matrices have been compressed into one dimension, which greatly reduces the computational cost of the attention mechanism.
(3.3) inputting the multitude of the coherent image pixel depth feature tokens in step (3.2) into a decoding module to obtain an estimation of relative depth; simultaneously, inputting the multitude of the coherent image pixel depth feature tokens in step (3.2) into a WT Bins module to obtain an estimation of absolute depth.

The decoding module comprises the Recover module and the Feature fusion module.

The function of Recover Module is to recombine the image tokens in the encoding stage into the feature expression of the image type, i.e., to combine the scattered tokens according to the initial positional encoding Eₚₒₛ, and connect them with each other to form the feature expression of the image form. The Recover Module comprises three steps, Project, Link, and Resample, and the mathematical expression of the whole process is as follows:

$$\begin{matrix}{Z}_{l}^{′} = Proj ( concat ( {Z}_{l} ) ) , {Z}_{l} ∈ {ℝ}^{( N + 1 ) \times D} , {Z}_{{l}^{′}} ∈ {ℝ}^{N \times D} \\ {Z}^{″} = Link ( {Z}_{l}^{′} ) , {Z}^{″} ∈ {ℝ}^{\frac{h}{p} \times \frac{w}{p} \times D} \\ \hat{Z} = Resample ( {Z}^{″} ) , \hat{Z} ∈ {ℝ}^{\frac{h}{r} \times \frac{w}{r} \times \hat{D}}\end{matrix}$$

wherein Zₗ is the coded image tokes, Z₁′ is the tokens after linear projection, Z″ is the feature representation in the form of an image by joining the tokens in a concatenation operation so that they form an image, and finally \hat{Z} is the result of the feature representation in the form of an image after dimensional transformation.

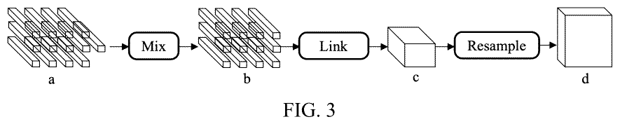

The general structure and data processing steps of the Recover module are shown in FIG. 3. The leftmost stereo rectangular block is the image tokens obtained after encoding, where the dispersed single token on the right side is the initial position encoding. The Mix operation is divided into two steps, firstly, the position encoded features are fused into each image tokens, and then the dispersed tokens are rearranged according to the initial encoding position. The Link operation is to reconnect the dispersed tokens so that an initial 2D planar feature representation of the image form is obtained. The final Resample operation is to change the dimensionality of the initial image features.

The Feature Fusion Module comprises a combination of residual convolution layers and an upsampling layer. The residual convolution layers are arranged in such a way that the two layers are connected sequentially, with residual connections in the outer layers, to further aggregate the feature expression results in the form of an image and to enlarge the sensory field of the model. Finally, the upsampling layer is placed at the end and uses a linear interpolation method to zoom in on the feature representation in image form twice at a time.

The WT Bins module comprises two wavelet transform-based convolutional neural network layers and a metric depth estimation module, where residual connections are added to the outside of the two wavelet convolution-based convolutional neural network layers to enhance the low-frequency response to multi-scale features from the bottleneck and to increase the global receptive field at that stage.

Image tokens are encoded into bin embeddings after passing through a convolutional neural network layer based on wavelet convolutional variations, and then the Bin center of individual pixel points is predicted using the MLP layer, and finally the absolute depth is calculated using the following formula:

$$D ( i ) = \frac{{\sum }_{k = 1}^{{B}_{total}} {P}_{i} ( k ) {C}_{i} ( k )}{{B}_{total}}$$

wherein i is an index of the pixel point; Bₜₒₜₐₗ represents the number of Bin center chains, which is the same as the number of input bottleneck features as 4; k is the index of Bₜₒₜₐₗ, which takes the value range of [0, Bₜₒₜₐₗ]; C and P are the depth of the current bin center and the score predicted after softmax, respectively.

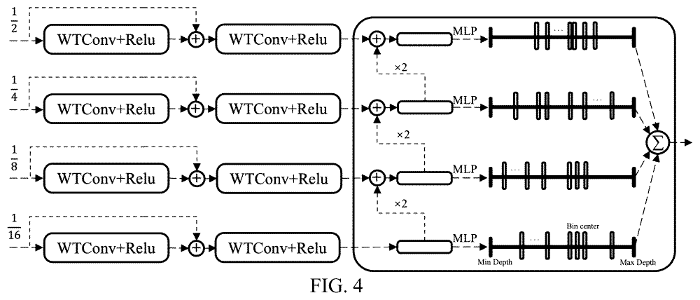

The overall structure and data processing flow of the WT Bins module is shown in FIG. 4. In the front end of the Bins structure, which is the 2d wavelet-based convolution layer, the activation function of each layer is ReLU, and the residual join operation is used (i.e., the initial input and the output after convolution are added together, which can well avoid the phenomenon of gradient explosion in the deeper layers of the model). As can be seen from the figure, each bin embeddings is projected into the Bin center chain by the MLP layer, and it should be noted that each Bin center chain has an artificially specified min depth and max depth, and in the port scenario constructed in the dataset, we limit the depth to the range of 0 m to 60 m.

The step (4) comprises the following steps:
(4.1) said distance estimation method of the lightweight attention mechanism distance estimation method for assisting visual navigation of a vehicle at a container terminal can be evaluated by employing four indicators, namely: absolute relative error AbsRel, root mean square error RMSE, log root mean square error RMSE, and the precise percentage of pixel threshold δₙ. Their calculation formulas are shown below:

$$\begin{matrix}AbsRel = \frac{1}{N} \sum \frac{\vert {y}_{i} - {\hat{y}}_{i} \vert}{{y}_{i}} \\ RMSE = \sqrt{\frac{1}{N} \sum {\vert {y}_{i} - {\hat{y}}_{i} \vert}^{2}} \\ {RMSE}_{log} = \sqrt{\frac{1}{N} \sum {\vert log {y}_{i} - log {\hat{y}}_{i} \vert}^{2}} \\ {δ}_{n} = [ max ( \frac{{y}_{i}}{{\hat{y}}_{i}} , \frac{{\hat{y}}_{i}}{{y}_{i}} ) < {thr}^{m} ] \% , thr = 1.25 , m = 1 ‵ 2 ‵ 3\end{matrix}$$

wherein i is an index of the pixel point in the RGB image, N is the total number of pixel points in a RGB image, yᵢ is the true value of the depth of the pixel point, and ŷᵢ is the depth prediction of the network.

The present invention also discloses a lightweight attention mechanism distance estimation model for the visual navigation of automated terminal vehicles, which is trained using the above-mentioned lightweight attention mechanism distance estimation method for the visual navigation of automated terminal vehicles.

In some other embodiments of the present invention, a lightweight attention mechanism distance estimation method for automated dock vehicle visual navigation is based on the Pytorch deep learning framework. The experimental environment is PyTorch 1.13, CUDA12.0, using the AdamW optimizer, the loss function uses SSIM, and the initial learning rate is set to {5e⁻⁵, 1e⁻⁴, 5e⁻⁴, 1e⁻³}. The input data samples are the training set and validation set in the dataset, and the output is the depth map formed by each color image and the true distance value corresponding to each of its pixels.

In order to quantitatively evaluate the lightweight attention mechanism distance estimation method for automated dock vehicle visual navigation proposed by the present invention, its prediction results are compared and contrasted with those of the DS-SIDE, AdaBins, LocalBins, MiDas and ZoeDepth models, and the absolute relative error AbsRel is adopted. The root mean square error RMSE, log root mean square error RMSE and the precise percentage δₙ of pixel threshold are used as evaluation indicators. Its calculation formula is as follows:

$$\begin{matrix}AbsRel = \frac{1}{N} \sum \frac{\vert {y}_{i} - {\hat{y}}_{i} \vert}{{y}_{i}} \\ RMSE = \sqrt{\frac{1}{N} \sum {\vert {y}_{i} - {\hat{y}}_{i} \vert}^{2}} \\ {RMSE}_{log} = \sqrt{\frac{1}{N} \sum {\vert log {y}_{i} - log {\hat{y}}_{i} \vert}^{2}} \\ {δ}_{n} = [ max ( \frac{{y}_{i}}{{\hat{y}}_{i}} , \frac{{\hat{y}}_{i}}{{y}_{i}} ) < {thr}^{m} ] \% , thr = 1.25 , m = 1 ‵ 2 ‵ 3\end{matrix}$$

wherein i is the index of the pixel point in the RGB image, N is the total number of pixel points in a RGB image, yᵢ is the true value of the depth of the pixel point, and ŷᵢ is the depth prediction of the network.

TABLE 1
Predictive performance of different algorithms at depth estimation

| | | | | | σ < | σ < | σ < |
|---|---|---|---|---|---|---|---|
| Scenes | Model | AbsRel | RMSE | RMSE_{log} | 1.25 | 1.25² | 1.25³ |
| Scenes | LocalBins | 0.099 | 0.351 | 0.043 | 0.907 | 0.986 | 0.998 |
| 1 | MiDas | 0.082 | 0.294 | 0.035 | 0.946 | 0.994 | 0.999 |
| | ZoeDepth | 0.075 | 0.270 | 0.032 | 0.955 | 0.995 | 0.999 |
| | ours | 0.059 | 0.206 | 0.024 | 0.984 | 0.998 | 1.000 |
| Scenes | LocalBins | 0.072 | 2.727 | 0.120 | 0.932 | 0.984 | 0.994 |
| 2 | MiDas | 0.062 | 2.573 | 0.092 | 0.959 | 0.995 | 0.999 |
| | ZoeDepth | 0.048 | 2.045 | 0.072 | 0.976 | 0.997 | 0.999 |
| | ours | 0.046 | 1.896 | 0.069 | 0.982 | 0.998 | 1.000 |

TABLE 2
Statistics on prediction speed and number
of parameters for different algorithms

| model | MiDas | LocalBins | ZoeDepth | ours |
|---|---|---|---|---|
| Parameters (m) | 109 | 134 | 159 | 323 |
| Predicted time (ms) | 30 | 24 | 39 | 33 |

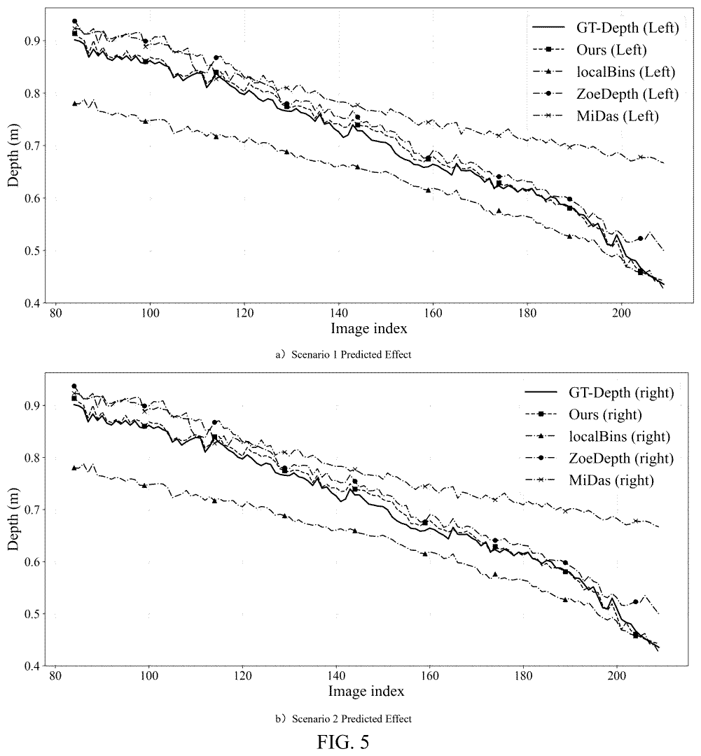

As can be seen from the results in Table 1, the model proposed in the present invention significantly outperforms previous state-of-the-art methods in the field of monocular depth estimation in all metrics, which reflects the effectiveness of the method architecture design of the present invention. Specifically, compared to ZoeDepth the monocular depth estimation framework of the present invention improves the RMSE by 23.7% and the AbsRel by 21.3%. Meanwhile, in Scene 2, which has a large depth variation range, the proposed model of the present invention also has about 7.2% improvement in RMSE compared to ZoeDepth, and in the metric of pixel threshold accuracy, only our model achieves a full accuracy of 1.000 at σ<1.25³. FIG. 5 shows the continuous integral distance prediction performance of the method and the comparison method under scenario 1 and scenario 2, from which it can be seen that the method and the real distance prediction error are minimal and the continuous accurate distance prediction tracking is realized.

Table 2 shows the inference times for the different models. The experimental statistics were performed on an Intel Core i7-10700K CPU @3.80 GHz with 16 cores and an NVIDIA RTX A4000 graphics card. A square image with a width of 480 pixels is used as the test data, and then the average of more than 250 runs is counted. It can be seen from the table that compared with networks based on fully convolutional architectures such as MiDas and LocalBins, the present invention uses the attention mechanism structure. Therefore, the number of parameters is greater than that of the two. Generally, the larger the number of parameters, the longer the prediction Time (time). However, the prediction time of the present invention is not significantly greater than that of MiDas and LocalBins. Compared with ZoeDepth, which also uses the attention lightweight mechanism, the present invention has a larger number of parameters and a better prediction effect (generally speaking, the model with a larger number of parameters has a better prediction effect). Moreover, when the number of parameters is greater than ZoeDepth, the reasoning time of the present invention is less than that of the ZoeDepth method. This reflects that the improved lightweight attention mechanism proposed by the present invention takes into account both accuracy and the beneficial effects of fast reasoning speed and low latency.

Although our model has a much larger number of parameters than other model architectures, thanks to the high parallelism inherent in the improved lightweight attention mechanism Squeeze Former itself and the reduction in computational complexity in the Q and K matrix channels, the framework proposed by the present invention has a similar delay to MiDas using a fully convolutional architecture. That is to take into account both the accuracy and timeliness of the prediction.

The present discloses a lightweight attention mechanism distance estimation method for assisting visual navigation of a vehicle at a container terminal. Firstly, using a depth monocular camera calibrated with the imaging parameters of the planar checkerboard tool to collect RGB-Depth image pairs in the working scenario of the automatic guided vehicle. Secondly, performing depth completion and manual annotation processing on the collected depth image. Thirdly, inputting image pairs into a lightweight monocular metric depth estimation framework which uses an improved lightweight attention mechanism Squeeze Former as the token mixer for training. Finally, fusing the results of relative depth estimation and absolute depth estimation to obtain a prediction of an actual distance between an object in the RGB image and the camera in the real world. The method and model provided by the present invention feature simple equipment, low cost, high timeliness of prediction and accurate results.

The content described in the embodiments of the present specification is only an enumeration of the forms of realization of the inventive idea, and the scope of protection of the invention should not be considered limited to the specific forms described in the embodiments, but the scope of protection of the invention also extends to equivalent technical means that can be thought of by a person skilled in the art according to the inventive idea.

What is claimed is:

1. A lightweight attention mechanism distance estimation method for assisting visual navigation of a vehicle at a container terminal, comprising the following steps:
(1) capturing a multitude of RGB images and a multitude of depth images in a working scenario of an Automated Guided Vehicle (AGV), by means of employing a depth monocular camera and calibrating the depth monocular camera using a multitude of imaging parameters obtained from a planar checkerboard tool;
(2) conducting depth-completion and manual annotation on the multitude of the depth images, said manual annotation being conducted by a professional by means of labelling or annotating the multitude of the depth images subsequent to depth-completion; correcting the multitude of the depth images of invalid depth-value to generate training data for a lightweight monocular metric depth estimation framework with enhanced attention mechanism; partitioning the training data into a multitude of training datasets, a multitude of validation datasets, and a multitude of test datasets;
(3) inputting the multitude of the training datasets and the multitude of the validation datasets into the lightweight monocular metric depth estimation framework with enhanced attention mechanism for training, to obtain an estimation of distance, comprising the following steps:
(3.1) processing the multitude of the RGB images in the multitude of the training datasets and the multitude of the validation datasets with image embedding, projecting each feature of each RGB image of the multitude of the RGB images into each high-dimensional image long sequence feature image token of a multitude of the high-dimensional image long sequence feature image tokens;
(3.2) encoding the multitude of the high-dimensional image long sequence feature image tokens, said encoding employing a backbone network sequentially stacked with Global Squeeze Blocks, and comprising the following steps: firstly, the improved lightweight attention mechanism Squeeze Former performing feature aggregation on the multitude of the high-dimensional image long sequence feature image tokens; subsequently, inputting the multitude of the high-dimensional image long sequence feature image tokens to an MLP layer to obtain an output; simultaneously, incorporating a multitude of residual connections to model long-range global interdependencies within the multitude of the high-dimensional image long sequence feature image tokens, thereby generating a multitude of coherent image pixel depth feature tokens; said modified lightweight attention mechanism, Squeeze Former, serving as a token mixer, performing average pooling on a key vector matrix (K matrix) and a value vector matrix (V matrix) in a multi-head attention mechanism, employing a learnable linear layer to embed the channel dimensions of a query vector matrix (Q matrix) and the K matrix into one dimension, a front of the improved lightweight attention mechanism Squeeze Former employing a spatial information-based adaptive weighting mechanism, the spatial information-based adaptive weighting mechanism employing a 2D convolutional neural network and incorporating a residual connection;
(3.3) inputting the multitude of the coherent image pixel depth feature tokens in step (3.2) into a decoding module to obtain an estimation of relative depth; simultaneously, inputting the multitude of the coherent image pixel depth feature tokens in step (3.2) into a WT Bins module to obtain an estimation of absolute depth;
(4) fusing the estimation of relative depth and the estimation of absolute depth, comprising the following steps: firstly, applying a SoftMax function to normalize the estimation of relative depth, to obtain a depth probability distribution for each image pixel; secondly, dividing the estimation of absolute depth into a multitude of local intervals, with a default pixel scale of 4×4 for each local interval of the multitude of the local intervals, and calculating a central value of each local interval of the multitude of the local intervals; finally, multiplying the distance central value of each local interval of the multitude of the local intervals by the corresponding probability in the depth probability distribution, realizing the fusing of the estimation of relative depth and the estimation of absolute depth; then output to obtain a prediction of each actual distance between each pixels of each in the multitude of the RGB images and the camera in the real world.

2. The lightweight attention mechanism distance estimation method for assisting visual navigation of a vehicle at a container terminal of claim 1, wherein the working scenario of the Automated Guided Vehicle (AGV) in step (1) referring to a multitude of working scenarios of AGV in an automated terminal: one or a multitude of traffic cones placed on a multitude of automated terminal roads, special-purpose vehicles operating normally on automated terminal roads, a multitude of containers arranged in one or more yards of the container terminal.

3. The lightweight attention mechanism distance estimation method for assisting visual navigation of a vehicle at a container terminal of claim 1, wherein said calibrating the depth monocular camera using the multitude of the imaging parameters obtained from a planar checkerboard tool in step (1) comprises: performing calibration according to Zhang's calibration method by employing the planar checkerboard tool to determine the multitude of the imaging parameters of the monocular depth camera, subsequently rectifying a multitude of imaging distortions employing the multitude of the imaging parameters.

4. The lightweight attention mechanism distance estimation method for assisting visual navigation of a vehicle at a container terminal of claim 1, wherein the depth-completion mentioned in S2 comprises the following steps:
(2.1) firstly, applying median filtering to the multitude of the depth images to remove noise and isolated pixel points, providing a cleaner data foundation for subsequent hole identification and completion;
(2.2) identifying regions with missing depth value, setting invalid depth value to 0 in the multitude of the depth images, thereby converting the multitude of the depth images into a multitude of binary images, employing numerical judgment to mark invalid pixel as 1 (representing the hole) and valid pixel as 0;
(2.3) applying morphological dilation operation to the multitude of the binary images to expand the edge of the hole, ensuring smooth boundary during subsequent interpolation; employing erosion operation to remove smaller isolated invalid a point to avoid misjudgment, filling the hole with depth value from adjacent valid pixel.

5. The lightweight attention mechanism distance estimation method for assisting visual navigation of a vehicle at a container terminal of claim 1, wherein a criterion for partitioning the training data in step (2) is as follows: dividing the training data so that the multitude of the training datasets constitute a largest percentage, while the multitude of the validation datasets and the multitude of the test datasets have equal proportion.

6. The lightweight attention mechanism distance estimation method for assisting visual navigation of a vehicle at a container terminal of claim 1, wherein the backbone network sequentially stacked with Global Squeeze Blocks in step (3.2) comprises a multitude of indefinite number of stacked Global Squeeze Blocks, resulting in configurable backbone network depth.

7. The lightweight attention mechanism distance estimation method for assisting visual navigation of a vehicle at a container terminal of claim 1, wherein a mathematical expression of the improved lightweight attention mechanism in step (3) is as follows:
$$\begin{matrix}SF ( {F}_{l - 1} ) = Concat ( {Head}_{0} , {Head}_{1} , … , {Head}_{j} ) W ° \\ {Head}_{j} = Attention ( Q , K , V ) = Softmax ( \frac{Q \cdot {K}^{T}}{\sqrt{{d}_{k}}} ) V \\ Q = {F}_{l - 1} {W}_{j}^{Q} , K = Avg Pool ( {F}_{l - 1} ) {W}_{j}^{K} , V = Avg Pool ( {F}_{l - 1} ) {W}_{j}^{V}\end{matrix}$$
wherein Q, K, V represent the query vector matrix, the key vector matrix and the value vector matrix in the multi-head attention mechanism respectively,
$${W}_{j}^{Q} ‵ {W}_{j}^{K} ‵ {W}_{j}^{V}$$
and W^{o} are a multitude of projection matrices, j represents an index number of the attention head, AvgPool is an average pooling layer, and Concat is a concatenation operation used to concatenate a multitude of results of a multitude of individual attention heads.

8. The lightweight attention mechanism distance estimation method for assisting visual navigation of a vehicle at a container terminal of claim 1, wherein a mathematical expression for dimensional change of the multitude of the RGB images with the image embedding process in step (3.1) is as follows:
$${I}_{p} ∈ {ℝ}^{N \times ( {P}^{2} \times C )} = proj ( reshape ( I ∈ {ℝ}^{H \times W \times C} ) )$$
wherein I represents an RGB image of the multitude of the RGB images, (H, W) represents a resolution size of each RGB image of the multitude of the RGB images, C represents a number of channels of each RGB image of the multitude of the RGB images.

9. The lightweight attention mechanism distance estimation method for assisting visual navigation of a vehicle at a container terminal of claim 1, wherein the decoding module in step (3.3) comprises a Recover module and a Feature fusion module; the function of Recover module is to recombine the multitude of the high-dimensional image long sequence feature image tokens in the encoding stage into an image-like feature representation, that is, to combine the multitude of the high-dimensional image long sequence feature image tokens according to their original positional encoding and connect them into an image-like feature representation; the function of the Feature fusion module is to further aggregate the image-like feature representation and expand receptive field of a model.

10. The lightweight attention mechanism distance estimation method for assisting visual navigation of a vehicle at a container terminal of claim 1, wherein the WT Bins module mentioned in step (3.3) comprises two layers of convolutional neural networks based on wavelet transform, along with an absolute distance estimation module, residual connection is added outside the two layers of wavelet transform-based convolutional neural networks to enhance the low-frequency response of multi-scale feature from the bottleneck of the backbone network and to increase the global receptive field at this stage.

11. A lightweight attention mechanism distance estimation model for assisting visual navigation of a vehicle at a container terminal, wherein said model is trained using the lightweight attention mechanism distance estimation method for assisting visual navigation of a vehicle at a container terminal of claim 6.

12. A lightweight attention mechanism distance estimation model for assisting visual navigation of a vehicle at a container terminal, wherein said model is trained using the lightweight attention mechanism distance estimation method for assisting visual navigation of a vehicle at a container terminal of claim 7.

13. A lightweight attention mechanism distance estimation model for assisting visual navigation of a vehicle at a container terminal, wherein said model is trained using the lightweight attention mechanism distance estimation method for assisting visual navigation of a vehicle at a container terminal of claim 8.

14. A lightweight attention mechanism distance estimation model for assisting visual navigation of a vehicle at a container terminal, wherein said model is trained using the lightweight attention mechanism distance estimation method for assisting visual navigation of a vehicle at a container terminal of claim 9.

15. A lightweight attention mechanism distance estimation model for assisting visual navigation of a vehicle at a container terminal, wherein said model is trained using the lightweight attention mechanism distance estimation method for assisting visual navigation of a vehicle at a container terminal of claim 10.
